(19) United States
(12) Patent Application Publication
(10) Pub. No.: US 2014/0003818 A1
(43) Pub. Date: Jan. 2, 2014

(54) EXTERNAL CAVITY LASER USING MULTILAYERED THIN FILM FILTER AND OPTICAL TRANSMITTER HAVING THE SAME

(71) Applicant: Electronics and Telecommunications Research Institute, Daejeon (KR)

(72) Inventors: Jie Hyun LEE, Daejeon (KR); Seung Hyun CHO, Daejeon (KR); Seung Il MYONG, Daejeon (KR); Sang Soo LEE, Daejeon (KR)

(21) Appl. No.: 13/928,570

(22) Filed: Jun. 27, 2013

(30) Foreign Application Priority Data
Jun. 27, 2012 (KR) 10-2012-0069313

(51) Int. Cl. H04B 10/50

(52) U.S. Cl. CPC H04B 10/503
USPC 398/88

(57) ABSTRACT

Provided is an external cavity laser using a multilayered thin film filter and an optical transmitter having the same. The external cavity laser may include a semiconductor laser diode to output an optical signal, a lens to cause the optical signal output from the semiconductor laser diode to converge, a multilayered thin film filter to receive the optical signal passed through the lens and to pass the optical signal in a bandpass wavelength range, and a partial reflector to transmit the optical signal transmitted through the multilayered thin film filter to an optical fiber.

### CROSS-REFERENCE TO RELATED APPLICATION

This application claims the priority benefit of Korean Patent Application No. 10-2012-0069313, filed on Jun. 27, 2012, in the Korean Intellectual Property Office, the disclosure of which is incorporated herein by reference.

### BACKGROUND

1. Field of the Invention

Exemplary embodiments relate to an external cavity laser and an optical transmitter having the same, and more particularly, to a wavelength division multiplexing optical transmitter used in a separation-type base station in a wired/wireless network.

2. Description of the Related Art

The advent of multifunctional portable devices, for example, smart phones, smart televisions (TVs), and the like, has resulted in heavy traffic in wired and wireless networks. Transitively, studies have been conducted on wavelength division multiplexing (WDM) in a wired subscriber network or an integrated wired/wireless subscriber network to cope with this issue efficiently. WDM is a technology that multiplexes a number of optical signals onto a single optical fiber by using different wavelengths of light emitted by a laser, and enables transmission and reception of multiple optical signals over one strand of an optical fiber. This technology has an advantage over other technologies in terms of security, quality of service (QoS), and protocol transparency due to a wavelength division multiplexed channel being present, and a further advantage of reduced line costs with an upper limit of a number of optical wavelengths accommodated by one strand of an optical fiber.

In applying the WDM technology, different wavelengths are assigned to each optical subscriber device to enable communications. Thus, a light source having a number of unique wavelengths corresponding to a number of subscribers of a wired subscriber network divided by remote nodes or a number of separation-type base stations in an integrated wired/wireless network is required. As a number of WDM light sources increases with the increasing number of optical subscriber devices, there is an increasing demand for a cost-efficient WDM light source to reduce the overall expenses.

In a distributed feedback (DFB) laser being used representatively as a WDM light source controlling a grating period and having performance compliant with International Telecommunication Union-Telecommunication Standardization Sector (ITU-T) standards dense wavelength division multiplexing (DWDM) wavelengths is not easy, and consequently, cost efficiency of a DWDM light source is low. As an alternative, an external cavity laser is a light source that outputs a single wavelength with an optical output performance similar to that of a DFB laser. The external cavity laser may include a gain medium unit acting as a laser diode or a semiconductor optical amplifier, and a wavelength selector to reflect a particular wavelength. The external cavity laser may be classified into a fiber Bragg grating external cavity laser (FBG-ECL) and a waveguide Bragg grating external cavity laser (WBG-ECL) based on a method of fabricating and configuring the wavelength selector.

The Bragg grating of the FBG-ECL may be achieved by a periodic variation in a refractive index of a fiber core of a photosensitive optical fiber under laser radiation. The refractive index of the photosensitive fiber varies with a change in temperature, and as a result, an output wavelength of the FBG-ECL varies with a change in temperature. The Bragg grating of the WBG-ECL may be fabricated by a periodic variation of an effective refractive index of an optical waveguide through etching of the optical waveguide. The refractive index of the waveguide varies with a change in temperature, and as a result, an output wavelength of the WBG-ECL varies with a change in temperature. Also, controlling the etching of the optical waveguide of is difficult and thus, use of the the WBG-ECL as a fixed-wavelength light source is inefficient.

### SUMMARY

An aspect of the present invention provides an external cavity laser using a multilayered thin film filter and a partial reflector to exhibit stable optical output characteristics irrespective of an external temperature change, in a wavelength division multiplexing (WDM) optical transmitter used in a wired network optical subscriber terminal device or a separation-type base station of an integrated wired/wireless network, and an optical transmitter having the same.

According to an aspect of the present invention, there is provided an external cavity laser including a semiconductor laser diode to output an optical signal, a lens to cause the optical signal output from the semiconductor laser diode to converge, a multilayered thin film filter to receive the optical signal passed through the lens and to pass the optical signal in a bandpass wavelength range, and a partial reflector to transmit the optical signal transmitted through the multilayered thin film filter to an optical fiber.

The multilayered thin film filter may be coupled to the partial reflector.

The multilayered thin film filter may be disposed a first predetermined distance away from the partial reflector.

The lens may be coupled to the multilayered thin film filter.

The lens may be disposed a second predetermined distance away from the multilayered thin film filter.

The multilayered thin film filter may have a front surface to which an anti-reflection (AR) coating may be applied, and a rear surface to which a multilayer thin-film coating may be applied.

The multilayered thin film filter may have a front surface to which a multilayer thin-film coating may be applied, and a rear surface to which an AR coating coating may be applied.

The multilayered thin film filter may have a front surface and a rear surface to which multilayer thin-film coatings may be applied.

According to another aspect of the present invention, there is provided an external cavity laser including a semiconductor laser diode to output an optical signal, a first lens to cause the optical signal output from the semiconductor laser diode to converge, a multilayered thin film filter to receive the optical signal passed through the first lens and to pass the optical signal in a bandpass wavelength range, and a second lens to transmit the optical signal transmitted through the multilayered thin film filter to an optical fiber.

The second lens may be coated with a material to be partially reflective.

The external cavity laser may further include a housing to prevent separation of the second lens and to fix the second lens.

The housing may be coupled to or disposed a predetermined distance away from the multilayered thin film filter.

According to still another aspect of the present invention, there is provided an optical transmitter having an external cavity laser, the external cavity laser of the optical transmitter including a semiconductor laser diode to output an optical signal, a lens to cause the optical signal output from the semiconductor laser diode to converge, a multilayered thin film filter to receive the optical signal passed through the lens and to pass the optical signal in a bandpass wavelength range, and a partial reflector to transmit the optical signal transmitted through the multilayered thin film filter to an optical fiber.

According to yet another aspect of the present invention, there is provided an optical transmitter having an external cavity laser, the external cavity laser of the optical transmitter including a semiconductor laser diode to output an optical signal, a first lens to cause the optical signal output from the semiconductor laser diode to converge, a multilayered thin film filter to receive the optical signal passed through the first lens and to pass the optical signal in a bandpass wavelength range, and a second lens to transmit a portion of the optical signal transmitted through the multilayered thin film filter to an optical fiber while reflecting the other portion of the optical signal.

According to further another aspect of the present invention, there is provided an optical transmitter having an external cavity laser, the external cavity laser of the optical transmitter including a semiconductor laser diode to output an optical signal, a first lens to cause the optical signal output from the semiconductor laser diode to converge, an optical fiber block to receive the optical signal passed through the first lens, a third lens to cause the optical signal passed through the optical fiber block to converge, a multilayered thin film filter to receive the optical signal passed through the third lens and to pass the optical signal in a bandpass wavelength range, and a partial reflector to transmit the optical signal transmitted through the multilayered thin film filter to an optical fiber.

The multilayered thin film filter may be separated.

The external cavity laser may further include a temperature sensor to measure a temperature, and a thermoelectric device to adjust the temperature.

The optical transmitter may be applied to a WDM approach.

The optical transmitter may be used in a wired network optical subscriber terminal device or a separation-type base station of an integrated wired/wireless network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of an external cavity laser according to a related art;

FIG. 2 is a diagram illustrating a configuration of a fiber Bragg grating external cavity laser (FBG-ECL) according to a related art;

FIG. 3 is a diagram illustrating a configuration of a wavelength Bragg grating external cavity laser (WBG-ECL) according to a related art;

FIG. 4 is a diagram illustrating filtering characteristics of a multilayered thin film filter according to a related art;

FIG. 5 is a diagram illustrating an external cavity laser using a multilayered thin film filter and a partial reflector according to an exemplary embodiment;

FIG. 6 is a diagram illustrating an external cavity laser using a multilayered thin film filter and a partial reflector according to another exemplary embodiment;

FIG. 7 is a diagram illustrating an external cavity laser with a multilayered thin film filter interposed between a semiconductor laser diode and a lens according to still another exemplary embodiment;

FIG. 8 is a diagram illustrating an external cavity laser using a multilayered thin film filter and a partial reflector according to yet another exemplary embodiment;

FIG. 9 is a diagram illustrating an external cavity laser with an optical fiber block receiving an optical signal passed through a first lens and a second lens causing light passed through the optical fiber block to converge again according to further another exemplary embodiment;

FIG. 10 is a diagram illustrating an incident light having a frequency outside a bandpass of a multilayered thin film filter according to an exemplary embodiment;

FIG. 11 is a diagram illustrating a bandpass spectrum of a multilayered thin film filter based on an incident angle of light falling on the multilayered thin film filter according to an exemplary embodiment;

FIG. 12 is a diagram illustrating a transistor outline (TO) package-type external cavity laser with an embedded thermoelectric device according to an exemplary embodiment;

FIG. 13 is a diagram illustrating an integral package-type external cavity laser with an embedded thermoelectric device according to an exemplary embodiment; and

FIG. 14 is a diagram illustrating a multilayered thin film filter interposed between lenses according to an exemplary embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

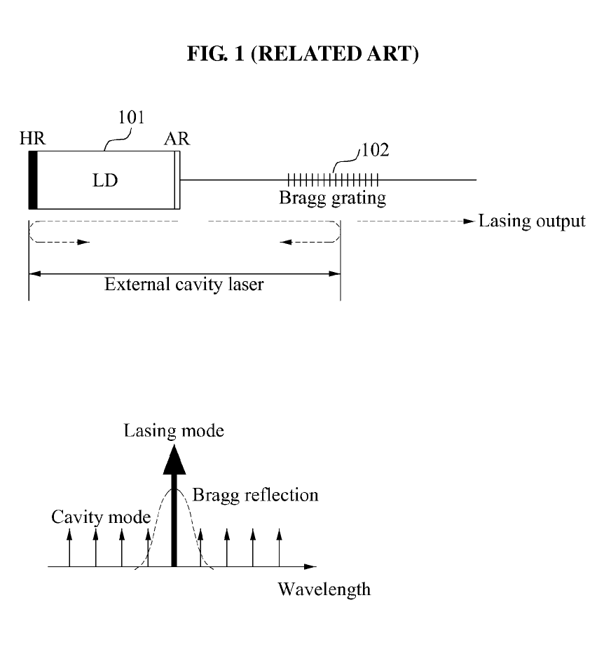

FIG. 1 is a diagram illustrating a configuration of an external cavity laser according to a related art.

Referring to FIG. 1, the external cavity laser may include a semiconductor laser diode 101 and a Bragg grating 102. Here, the semiconductor laser diode 101 may serve as a gain medium, and the Bragg grating 102 may act as a selective wavelength filter for selecting a wavelength of an optical signal output from the semiconductor laser diode 101.

The semiconductor laser diode 101 may have an active medium to output an optical signal. The active medium may have a light emitting surface to which an anti-reflection (AR) coating may be applied and a rear surface to which a high-reflection (HR) coating may be applied.

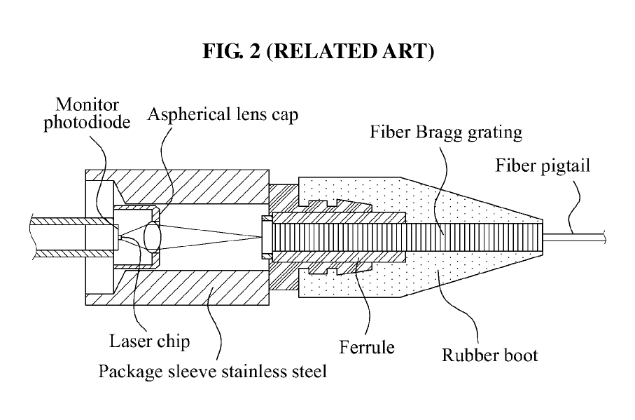

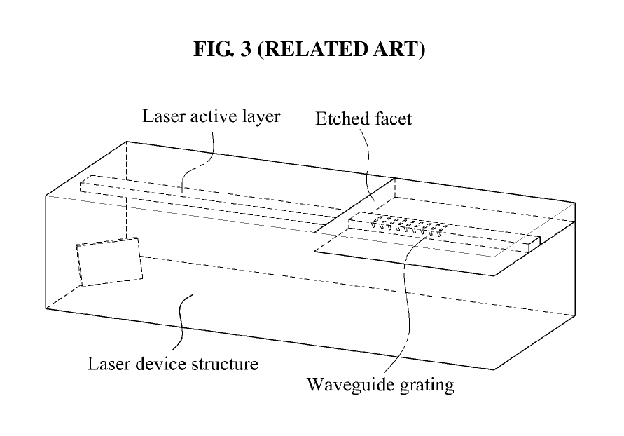

The semiconductor laser diode 101 may form an external resonator with the Bragg grating 102. As an example, the Bragg grating 102 may correspond to a fiber Bragg grating created by inscribing a Bragg grating into a photosensitive optical fiber, as shown in FIG. 2. As another example, the Bragg grating 102 may correspond to a waveguide Bragg grating fabricated by etching a part of an optical waveguide, as shown in FIG. 3.

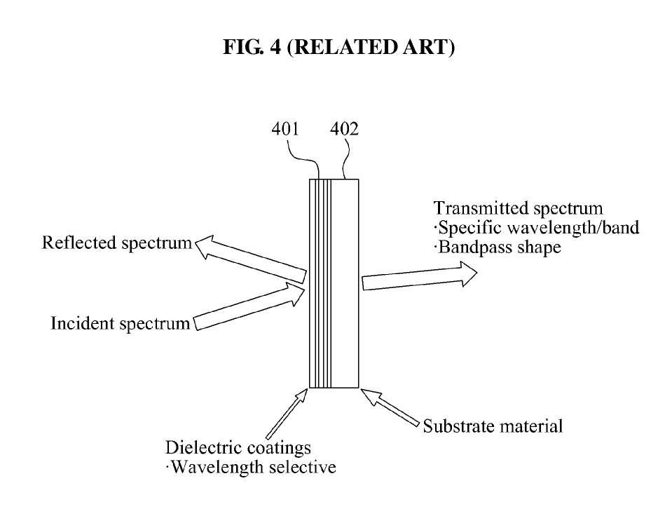

FIG. 4 is a diagram illustrating filtering characteristics of a multilayered thin film filter according to a related art.

The Bragg grating 102 of FIG. 1 may perform a function of a wavelength selective filter. According to an exemplary embodiment, in lieu of a Bragg grating, a wavelength selective filter may be composed of a multilayered thin film filter and a partial reflector.

Referring to FIG. 4, the multilayered thin film filter may comprise a transparent block substrate having a rear surface 401 and a front surface 402. The rear surface 401 may have an AR coating, and the front surface 402 may have a multilayer thin-film coating. Also, the AR coating may be applied to one surface of the rear surface 401 and the front surface 402 of the multilayered thin film filter. The multilayered thin film filter may only allow a desired wavelength of light to pass through the rear surface 401 and the front surface 402. According to another exemplary embodiment, the rear surface 401 and the front surface 402 may have multilayer thin-film coatings. In this instance, desired optical characteristics may be obtained by adjusting a refractive index of a multilayer thin-film coating material, a coating thickness, and a number of layers.

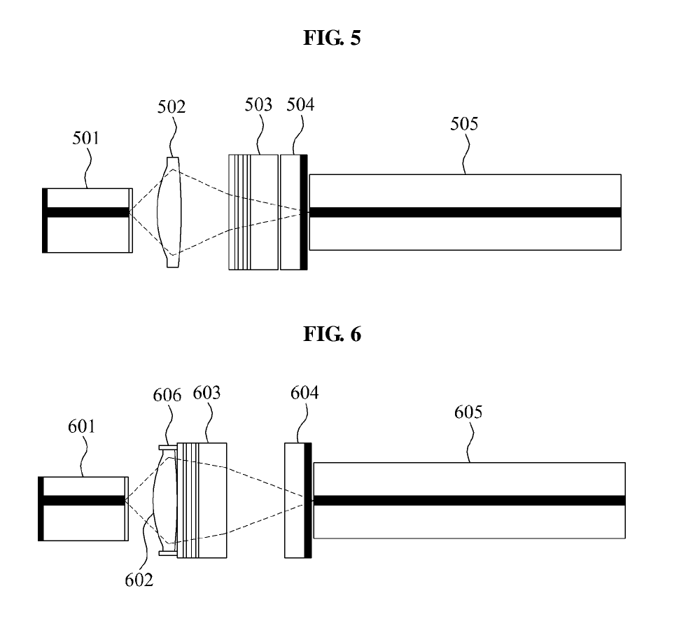

FIG. 5 is a diagram illustrating an external cavity laser using a multilayered thin film filter and a partial reflector according to an exemplary embodiment.

Referring to FIG. 5, the external cavity laser may include a semiconductor laser diode 501, a lens 502, a multilayered thin film filter 503, and a partial reflector 504. Light from the external cavity laser may be transmitted outwards through a single mode optical fiber 505.

The external cavity laser made up of the semiconductor laser diode 501, the lens 502, the multilayered thin film filter 503, and the partial reflector 504 may comprise an optic transmit package. In this instance, the optic transmit package may correspond to a transistor outline (TO) can package.

The lens 502 may cause light output from the semiconductor laser diode 501 to converge. For example, when an optical signal is output from the semiconductor laser diode 501 to which an electric current is applied, the output optical signal may pass through the lens 502 to form an image at a predetermined distance.

The optical signal passed through the lens 502 may reach the multilayered thin film filter 503 and the partial reflector 504. The multilayered thin film filter 503 and the partial reflector 504 may select a wavelength of the optical signal output from the semiconductor laser diode 501.

The multilayered thin film filter 503 and the partial reflector 504 may be formed integrally such that the multilayered thin film filter 503 may be connected with the partial reflector 504 directly. An AR coating may be applied to a front surface of the multilayered thin film filter 503 in contact with the partial reflector 504, and a multilayer thin-film coating may be applied to a rear surface of the multilayered thin film filter 503.

In this instance, desired optical characteristics may be obtained by adjusting a refractive index of a multilayer thin-film coating material, a coating thickness, and a number of layers. Also, the multilayered thin film filter 503 and the partial reflector 504 may be disposed at a predetermined angle with respect to a plane.

The external cavity laser may be applied to a wavelength division multiplexing (WDM) approach, and may be used in a wired network optical subscriber terminal device or a separate-type base station of an integrated wired/wireless network.

FIG. 6 is a diagram illustrating an external cavity laser using a multilayered thin film filter and a partial reflector according to another exemplary embodiment.

Referring to FIG. 6, the external cavity laser may include a semiconductor laser diode 601, a lens 602, a multilayered thin film filter 603, and a partial reflector 604. Light from the external cavity laser may be transmitted outwards through a single mode optical fiber 605.

Dissimilar to FIG. 5, the multilayered thin film filter 603 may be disposed a predetermined distance away from the partial reflector 604. The multilayered thin film filter 603 may be coupled to a housing 606 of the lens 602. As another example, the multilayered thin film filter 603 may be disposed a predetermined distance away from the lens 602.

Although not shown in FIG. 6, the external cavity laser may further include a thermoelectric device. The thermoelectric device may adjust a temperature of the semiconductor laser diode 601. The semiconductor laser diode 601 may be mounted on the thermoelectric device. The thermoelectric device may include a temperature sensor to monitor the temperature of the semiconductor laser diode 601. The temperature sensor may be mounted on the thermoelectric device to measure the temperature of an upper plate of the thermoelectric device. The thermoelectric device may control the temperature of the semiconductor laser diode 601 using the temperature measured by the temperature sensor.

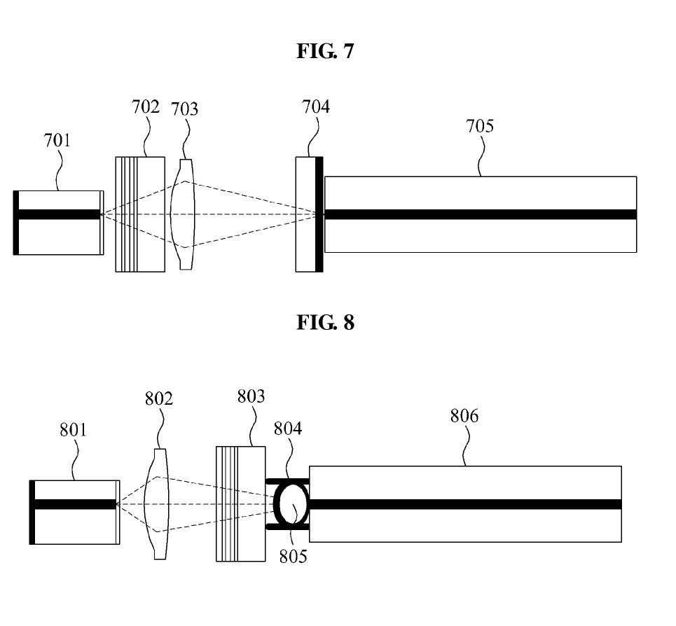

FIG. 7 is a diagram illustrating an external cavity laser with a multilayered thin film filter interposed between a semiconductor laser diode and a lens according to still another exemplary embodiment.

Referring to FIG. 7, the external cavity laser may include a semiconductor laser diode 701, a multilayered thin film filter 702, a lens 703, and a partial reflector 704. Light from the external cavity laser may be transmitted outwards through a single mode optical fiber 705.

The multilayered thin film filter 702 may be interposed between the semiconductor laser diode 701 and the lens 703. The multilayered thin film filter 702 may select a wavelength of an optical signal output from the semiconductor laser diode 701. The selected optical signal may reach the partial reflector 705 through the lens 703.

Although not shown in FIG. 7, the external cavity laser may further include a thermoelectric device. The thermoelectric device may adjust a temperature of the semiconductor laser diode 701. The semiconductor laser diode 701 may be mounted on the thermoelectric device. The thermoelectric device may include a temperature sensor to monitor the temperature of the semiconductor laser diode 701. The temperature sensor may be mounted on the thermoelectric device to measure the temperature of an upper plate of the thermoelectric device. The thermoelectric device may control the temperature of the semiconductor laser diode 701 using the temperature measured by the temperature sensor.

FIG. 8 is a diagram illustrating an external cavity laser using a multilayered thin film filter and a partial reflector according to yet another exemplary embodiment.

Referring to FIG. 8, the external cavity laser may include a semiconductor laser diode 801, a first lens 802, a multilayered thin film filter 803, a housing 804, and a second lens 805. Light from the external cavity laser may be transmitted outwards through a single mode optical fiber 806.

Dissimilar to FIGS. 5 and 6, the external cavity laser may include two lenses. The second lens 805 may be disposed inside the housing 804, and may be surface-coated with a material to be partially reflective. A refractive index of the coating material may be adjustable. The multilayered thin film filter 803 may be coupled to the housing 804 in a planar manner.

Although not shown in FIG. 8, the external cavity laser may further include a thermoelectric device. The thermoelectric device may adjust a temperature of the semiconductor laser diode 801. The semiconductor laser diode 801 may be mounted on the thermoelectric device. The thermoelectric device may include a temperature sensor to monitor the temperature of the semiconductor laser diode 801. The temperature sensor may be mounted on the thermoelectric device to measure the temperature of an upper plate of the thermoelectric device. The thermoelectric device may control the temperature of the semiconductor laser diode 801 using the temperature measured by the temperature sensor.

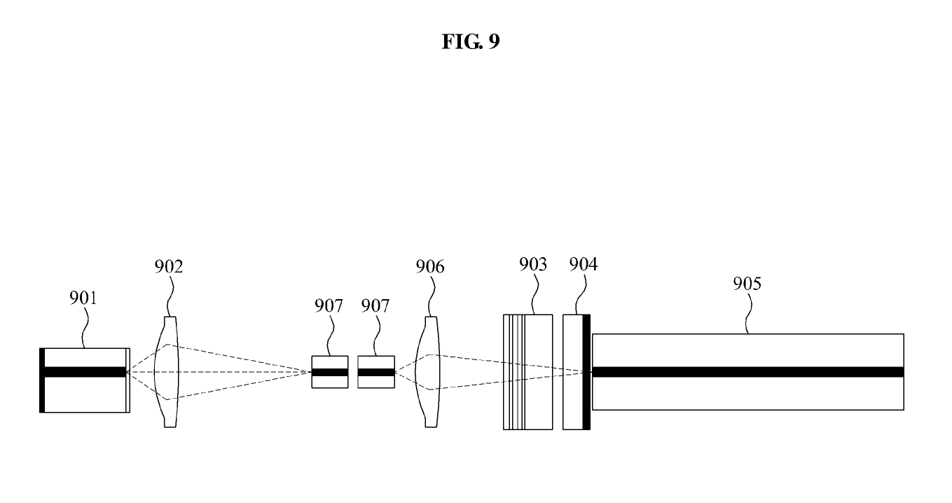

FIG. 9 is a diagram illustrating an external cavity laser with an optical fiber block receiving an optical signal passed through a first lens and a second lens causing light passed through the optical fiber block to converge again according to further another exemplary embodiment.

Dissimilar to FIGS. 5 through 8, the external cavity laser may include an optical fiber block 907 between a semiconductor laser diode 901 and a multilayered thin film filter 903. A second lens 906 may cause an output from the optical fiber block 907 to converge.

Referring to FIG. 9, the optical fiber block 907 may receive an optical signal passed through a first lens 902 that may cause the optical signal output from the semiconductor laser diode 901 to converge. The second lens 906 may cause light passed through the optical fiber block 907 to converge. The multilayered thin film filter 903 may filter the optical signal received from the second lens 906 to allow transmission of a bandpass wavelength. Also, the external cavity laser may include a partial reflector 904 to transmit the optical signal transmitted through the multilayered thin film filter 903 to an optical fiber 905.

Although not shown in FIG. 9, the external cavity laser may further include a thermoelectric device. The thermoelectric device may adjust a temperature of the semiconductor laser diode 901. The semiconductor laser diode 901 may be mounted on the thermoelectric device. The thermoelectric device may include a temperature sensor to monitor the temperature of the semiconductor laser diode 901. The temperature sensor may be mounted on the thermoelectric device to measure the temperature of an upper plate of the thermoelectric device. The thermoelectric device may control the temperature of the semiconductor laser diode 901 using the temperature measured by the temperature sensor.

The external cavity lasers of FIGS. 5, through 9 may be included in an optical transmitter. The optical transmitter may be applied to a WDM approach. Also, the optical transmitter may be used in a wired network optical subscriber terminal device or a separation-type base station of an integrated wired/wireless network.

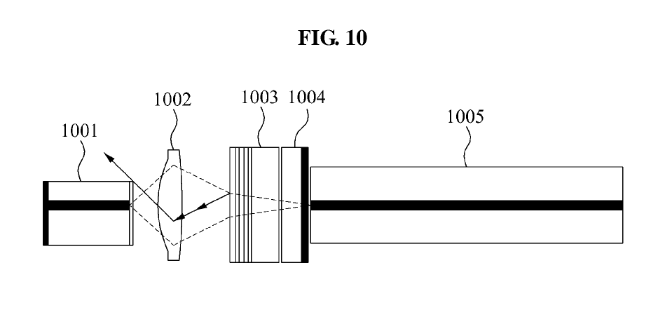

FIG. 10 is a diagram illustrating an incident light having a frequency other than a frequency corresponding to a bandpass of a multilayered thin film filter in an external cavity laser according to an exemplary embodiment.

The external cavity laser may have the same structure as that of FIG. 5. However, the technical features of the external cavity lasers of FIGS. 6, through 8 may be applied. Referring to FIG. 10, an optical signal output from a semiconductor laser diode 1001 may fall on a multilayered thin film filter 1003 at a predetermined angle through a lens 1002.

When the incident optical signal has a frequency outside a bandpass, the optical signal may be reflected on the multilayered thin film filter 1003 and a partial reflector 1004. The reflected optical signal may fail to return to the semiconductor laser diode 1001. For example, as seen in FIG. 10, the reflected optical signal may fail to turn back to a semiconductor optical amplifier, such that multimode lasing in an unwanted wavelength range due to the reflected optical signal may be prevented.

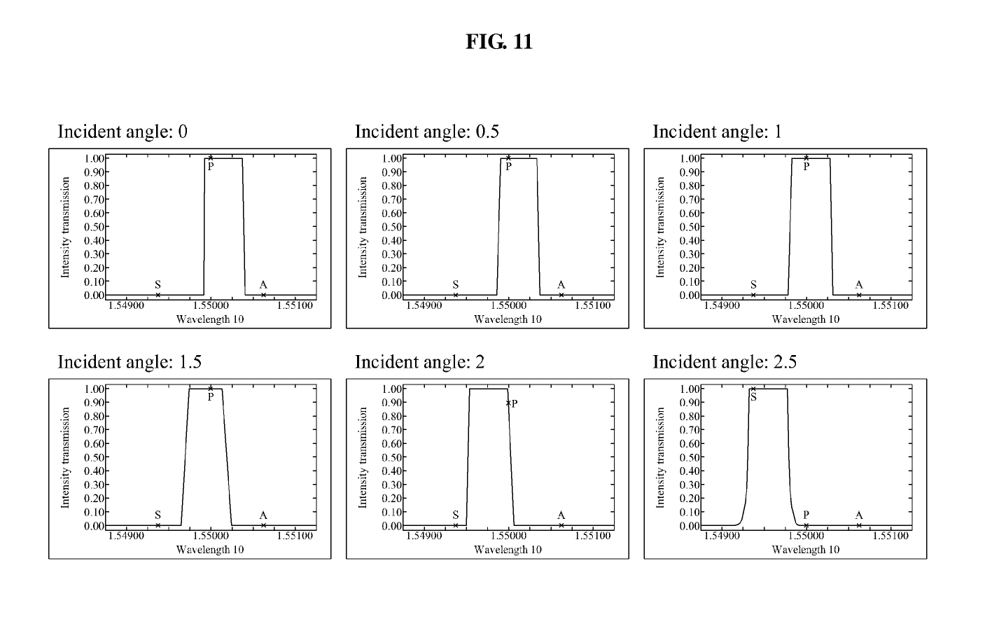

FIG. 11 is a diagram illustrating a bandpass spectrum of a multilayered thin film filter based on an incident angle of light falling on the multilayered thin film filter according to an exemplary embodiment.

In FIG. 10, when the optical signal focused via the lens 1002 falls on the multilayered thin film filter 1003, a bandpass spectrum of the multilayered thin film filter 1003 may differ based on an incident angle of the optical signal falling on the multilayered thin film filter 1003.

Accordingly, a lasing wavelength satisfying a resonance condition in the external cavity laser made up of the semiconductor laser diode having an HR coating, the multilayered thin film filter, and the partial reflector may be a part of the bandpass wavelength range of the multilayered thin film filter performing an operation of wavelength selection. Therefore, the external cavity lasers of FIGS. 5, through 9 may form a single wavelength laser, and the external cavity lasers of FIGS. 5, 8, and 9 may be constructed to select an output wavelength by separating the multilayered thin film filters.

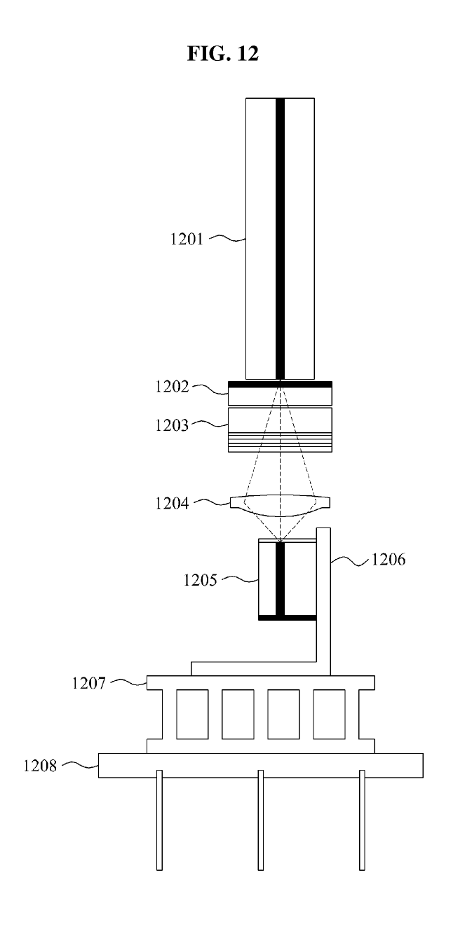

FIG. 12 is a diagram illustrating a TO package-type external cavity laser with an embedded thermoelectric device according to an exemplary embodiment.

Referring to FIG. 12, the external cavity laser may include a semiconductor laser diode 1205, a lens 1204, a multilayered thin film filter 1203, and a partial reflector 1202. Light from the external cavity laser may be transmitted outwards through a single mode optical fiber 1201. The external cavity laser made up of the semiconductor laser diode 1205, the lens 1204, the multilayered thin film filter 1203, and the partial reflector 1202 may be included in a TO package 1208 provided with a thermoelectric device 1207.

The thermoelectric device 1207 may adjust a temperature of the semiconductor laser diode 1205. The semiconductor laser diode 1205 may be mounted on the thermoelectric device 1207. The thermoelectric device 1207 may include a temperature sensor to monitor the temperature of the semiconductor laser diode 1205. The temperature sensor may be mounted on the thermoelectric device 1207 to measure the temperature of an upper plate of the thermoelectric device 1207. The thermoelectric device 1207 may control the temperature of the semiconductor laser diode 1205 using the temperature measured by the temperature sensor.

The semiconductor laser diode 1205 may output the optical signal to the lens 1204. The lens 1204 may cause the optical signal output from the semiconductor laser diode 1205 to converge to form an image at a predetermined distance. The optical signal passed through the lens 1204 may reach the multilayered thin film filter 1203 and the partial reflector 1202 that may select a wavelength of the optical signal output from the semiconductor laser diode 1205.

The multilayered thin film filter 1203 and the partial reflector 1202 may be formed integrally such that the multilayered thin film filter 1203 may be connected with the partial reflector 1202 directly. Also, the multilayered thin film filter 1203 may be disposed a predetermined distance away from the partial reflector 1202. The multilayered thin film filter 1203 may be coupled to a housing of the lens 1204.

The external cavity laser may have the same structure as those of FIGS. 5, through 9.

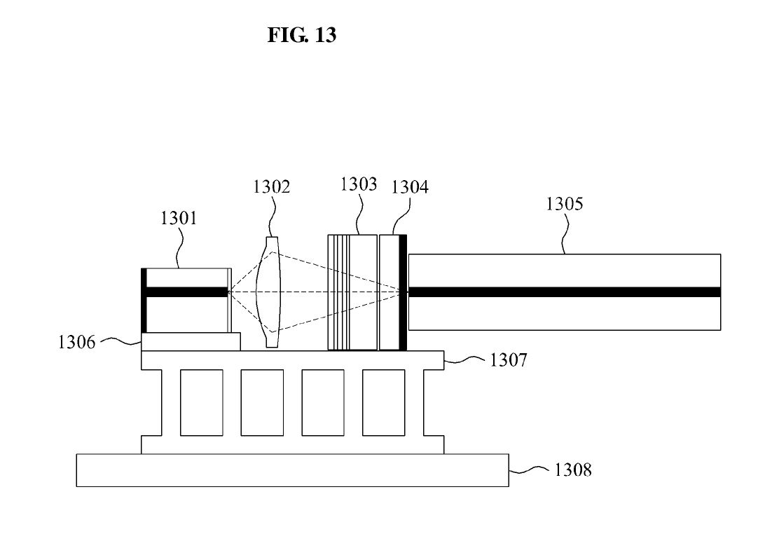

FIG. 13 is a diagram illustrating an integral package-type external cavity laser with an embedded thermoelectric device according to an exemplary embodiment.

Referring to FIG. 13, the external cavity laser may include a semiconductor laser diode 1301, a lens 1302, a multilayered thin film filter 1303, and a partial reflector 1304. Light from the external cavity laser may be transmitted outwards through a single mode optical fiber 1305. The external cavity laser made up of the semiconductor laser diode 1301, the lens 1302, the multilayered thin film filter 1303, and the partial reflector 1304 may be included in an integral package 1308 provided with a thermoelectric device 1307. The integral package 1308 may correspond to a butterfly package in a form of boiler tube failures (BTF) or a mini-dual in-line (DIL) package.

The thermoelectric device 1307 may adjust a temperature of the external resonator. At least one of the semiconductor laser diode 1301, the lens 1302, and the multilayered thin film filter 1303 may be mounted on the thermoelectric device 1307. The thermoelectric device 1307 may include a temperature sensor to monitor a temperature of at least one of the semiconductor laser diode 1301, the lens 1302, and the multilayered thin film filter 1303. The thermoelectric device 1307 may have the temperature sensor mounted on the thermoelectric device 1307. The temperature sensor may measure the temperature of at least one of the semiconductor laser diode 1301, the lens 1302, and the multilayered thin film filter 1303. The thermoelectric device 1307 may control the temperature of the external cavity laser using the temperature measured by the temperature sensor.

The thermoelectric device 1307 may include the partial reflector 1304, as necessary. In this instance, the partial reflector 1304 may be mounted on the thermoelectric device 1307 to monitor the temperature. Also, the thermoelectric device 1307 may measure the temperature of the partial reflector 1304.

The semiconductor laser diode 1301 may output the optical signal to the lens 1302. The lens 1302 may cause the optical signal output from the semiconductor laser diode 1301 to converge to form an image at a predetermined distance. The optical signal passed through the lens 1302 may reach the multilayered thin film filter 1303 and the partial reflector 1304 that may select a wavelength of the optical signal output from the semiconductor laser diode 1301.

The multilayered thin film filter 1303 and the partial reflector 1304 may be formed integrally such that the multilayered thin film filter 1303 may be connected with the partial reflector 1304 directly. Also, the multilayered thin film filter 1303 may be disposed a predetermined distance away from the partial reflector 1304. The multilayered thin film filter 1303 may be coupled to a housing of the lens 1302.

The external cavity laser may have the same structure as those of FIGS. 5, through 9.

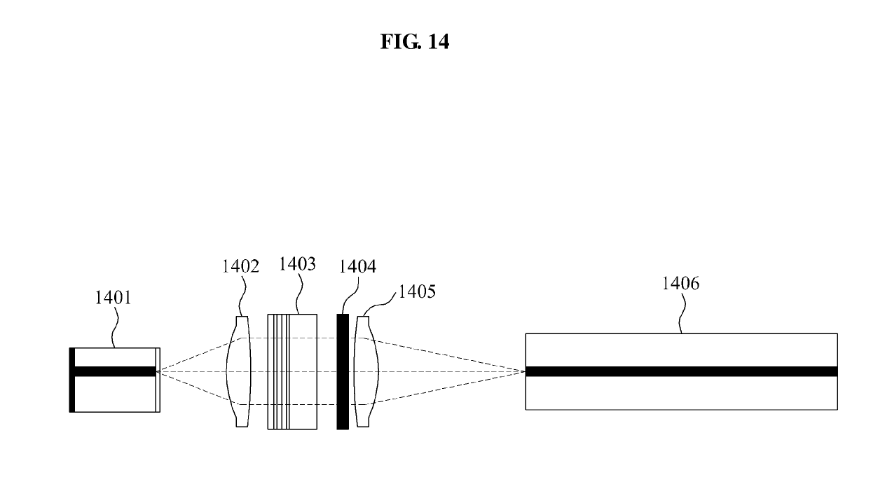

FIG. 14 is a diagram illustrating a multilayered thin film filter interposed between lenses according to an exemplary embodiment.

Referring to FIG. 14, the external cavity laser may include a semiconductor laser diode 1401, a first lens 1402, a multilayered thin film filter 1403, and a second lens 1405. Light from the external cavity laser may be transmitted outwards through a single mode optical fiber 1406.

Dissimilar to FIGS. 5, through 7, the external cavity laser may include two lenses. The semiconductor laser diode 1401 may output an optical signal to the first lens 1402. The first lens 1402 may correspond to a collimating lens. Also, the second lens 1405 may correspond to a collimating lens. For example, the external cavity laser including the collimating lenses may shorten the length of the external resonator when compared to a case using a focusing lens, which may be favorable for rapid operation of the external cavity laser. The output optical signal may reach the multilayered thin film filter 1403 through the first lens 1402 and may pass through the second lens 1405. The second lens 1405 may be formed as a part of an optical fiber.

According to exemplary embodiments, using the multilayered thin film filter, the external cavity laser may exhibit stable optical output characteristics even though an outside temperature changes.

According to exemplary embodiments, the optical transmitter may eliminate the need for an additional feature for maintaining an output wavelength stably, and as a consequence, the need to monitor an optical output wavelength, resulting in cost reduction.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An external cavity laser comprising:
a semiconductor laser diode to output an optical signal;
a lens to cause the optical signal output from the semiconductor laser diode to converge;
a multilayered thin film filter to receive the optical signal passed through the lens and to pass the optical signal in a bandpass wavelength range; and
a partial reflector to transmit the optical signal transmitted through the multilayered thin film filter to an optical fiber.

2. The external cavity laser of claim 1, wherein the multilayered thin film filter is coupled to the partial reflector.

3. The external cavity laser of claim 1, wherein the multilayered thin film filter is disposed a first predetermined distance away from the partial reflector.

4. The external cavity laser of claim 1, wherein the lens is coupled to the multilayered thin film filter.

5. The external cavity laser of claim 1, wherein the lens is disposed a second predetermined distance away from the multilayered thin film filter.

6. The external cavity laser of claim 1, wherein the multilayered thin film filter has a front surface to which an anti-reflection (AR) coating is applied, and a rear surface to which a multilayer thin-film coating is applied, and
the AR coating is applied to one surface of the front surface and the rear surface of the multilayered thin film filter.

7. The external cavity laser of claim 1, wherein the multilayered thin film filter has a front surface and a rear surface to which multilayer thin-film coatings are applied.

8. The external cavity laser of claim 1, wherein the multilayered thin film filter is coupled to or separated from at least one of the semiconductor laser diode, the lens, and the partial reflector, and
the multilayered thin film filter is interposed between the semiconductor laser diode and the lens.

9. The external cavity laser of claim 1, wherein the semiconductor laser diode, the lens, the multilayered thin film filter, and the partial reflector may comprise:
a thermoelectric device to measure and control a temperature of the semiconductor laser diode, the lens, the multilayered thin film filter, and the partial reflector;
a metal substrate to connect the thermoelectric device with the semiconductor laser diode, the lens, the multilayered thin film filter, and the partial reflector; and
a package to assemble the thermoelectric device, the semiconductor laser diode, the lens, the multilayered thin film filter, and the partial reflector, into one.

10. The external cavity laser of claim 1, wherein the external cavity laser is applied to a wavelength division multiplexing (WDM) approach, and is used in a wired network optical subscriber terminal device or a separate-type base station of an integrated wired/wireless network.

11. An external cavity laser comprising:
a semiconductor laser diode to output an optical signal;
a first lens to cause the optical signal output from the semiconductor laser diode to converge;
a multilayered thin film filter to receive the optical signal passed through the first lens and to pass the optical signal in a bandpass wavelength range; and
a second lens to transmit the optical signal transmitted through the multilayered thin film filter to an optical fiber.

12. The external cavity laser of claim 11, wherein the second lens is coated with a material to be partially reflective.

13. The external cavity laser of claim 12, further comprising:
a housing to prevent separation of the second lens and to fix the second lens,
wherein the housing is coupled to or disposed a predetermined distance away from the multilayered thin film filter.

14. The external cavity laser of claim 11, wherein the first lens and the second lens corresponds to a collimating lens to collimate the optical signal output from the semiconductor laser diode.

15. The external cavity laser of claim 11, wherein the second lens is formed as a part of an optical fiber.

16. The external cavity laser of claim 11, wherein the external cavity laser is applied to a wavelength division multiplexing (WDM) approach, and is used in a wired network optical subscriber terminal device or a separate-type base station of an integrated wired/wireless network.

17. An optical transmitter having an external cavity laser, wherein the external cavity laser of the optical transmitter comprises:
a semiconductor laser diode to output an optical signal;
a lens to cause the optical signal output from the semiconductor laser diode to converge;
a multilayered thin film filter to receive the optical signal passed through the lens and to pass the optical signal in a bandpass wavelength range; and
a partial reflector to transmit the optical signal transmitted through the multilayered thin film filter to an optical fiber.

18. The optical transmitter of claim 17, wherein the optical transmitter is applied to a wavelength division multiplexing (WDM) approach, and is used in a wired network optical subscriber terminal device or a separate-type base station of an integrated wired/wireless network.

19. An optical transmitter having an external cavity laser, wherein the external cavity laser of the optical transmitter comprises:
a semiconductor laser diode to output an optical signal;
a first lens to cause the optical signal output from the semiconductor laser diode to converge;
a multilayered thin film filter to receive the optical signal passed through the first lens and to pass the optical signal in a bandpass wavelength range; and
a second lens to transmit a portion of the optical signal transmitted through the multilayered thin film filter to an optical fiber.

20. The optical transmitter of claim 19, wherein the optical transmitter is applied to a wavelength division multiplexing (WDM) approach, and is used in a wired network optical subscriber terminal device or a separation-type base station of an integrated wired/wireless network.
